(19) United States
(12) Patent Application Publication
(10) Pub. No.: US 2013/0080841 A1
(43) Pub. Date: Mar. 28, 2013

(54) RECOVER TO CLOUD: RECOVERY POINT OBJECTIVE ANALYSIS TOOL

(71) Applicants: CHANDRA REDDY, SAN RAMON, CA (US); DANIEL GARDNER, DANVILLE, CA (US)

(72) Inventors: CHANDRA REDDY, SAN RAMON, CA (US); DANIEL GARDNER, DANVILLE, CA (US)

(73) Assignee: SunGard Availability Services, Wayne, PA (US)

(21) Appl. No.: 13/242,739

(22) Filed: Sep. 23, 2011

(51) Int. Cl. G06F 11/00

(52) U.S. Cl. 714/47.3; 714/E11.02

(57) ABSTRACT

An amount of a resource, such as bandwidth, needed to successfully accomplish a target Recovery Point Objective (RPO) is estimated in a data processing environment giving two or more physical or virtual data processing machines. Time-stamped samples of a usage metric for the resource are taken over a usage period. These samples are later accessed and time aligned to determine an average usage metric at defined intervals. An expected tolerance for RPO failure allows determining a first assumed amount of the resource available to achieve a target RPO that is less than might otherwise be expected. These steps can be repeated for other expected replication failure tolerances to allow a risk versus resource available trade off analysis.

### BACKGROUND

Replication of data processing systems to maintain operational continuity is now required in almost all enterprises. The costs incurred during downtime when information technology equipment is not available can be significant, and sometimes even cause an enterprise to halt operations completely. With replication, aspects of the data processors that may change rapidly over time, such as their program and data files, physical volumes, file systems, etc. are duplicated on a continuous basis. Replication may be used for many purposes such as assuring data availability upon equipment failure, site disaster recovery or planned maintenance operations.

Replication may be directed to either the physical or virtual processing environment and/or different abstraction level. For example, one may undertake to replicate each physical machine exactly as it exists at a given time. However, replication processes may also be architected along virtual data processing lines, with corresponding virtual replication processes, with the end result being to remove physical boundaries and limitations associated with particular physical machines.

Use of a replication service as provided by a remote or hosted external service provider can have numerous advantages. Replication services can provide continuous availability and failover capabilities that are more cost effective than an approach which has the data center operator owning, operating and maintaining a complete suite of duplicate machines at its own data center. With such replication services, physical or virtual machine infrastructure is replicated at a remote and secure data center “in the cloud” from the perspective of the operator of the production system.

In the case of virtual replication, a virtual disk file containing the server operating system, data, and applications from the production environment is retained in a dormant state. In the event of a disaster, the virtual disk file is moved to a production mode within a virtual environment at the remote and secure data center. Applications and data can then be accessed on the remote virtualized infrastructure, enabling the data center to continue operating while recovering from a disaster.

Replication services typically gain access to the production environment through a vehicle such as a replication agent. The replication agent(s) operate asynchronously and continuously as a background process.

The effectiveness of replication services can be measured by various metrics. Among the most common metrics are Recovery Time Objective (RTO) and Recovery Point Objective (RPO). Recovery Time Objective attempts to measure how much time it will take to recover the replicated data. RPO, on the other hand, is a measure of acceptable data loss measure to a point in the past.

For example, if the RPO is two hours, then when a system is brought back on line after a disaster, all data must be restored to the same point as it was within two hours before the disaster. In other words, the replication service customer agreeing to an RPO of two hours has acknowledged that any data changes occurring prior to the two hours immediately preceding a disaster may be lost—thus the acceptable loss window is two hours. RPO is thus independent of the time it takes to get a functional system back on-line—that of course being the RTO.

### SUMMARY OF PREFERRED EMBODIMENTS

Effective implementation of a replication service therefore requires careful consideration of the data processing resources needed for implementation. These resources not only include the amount of physical or virtual storage to allocate to the replicated virtual disk file(s), but other resources, such as network bandwidth, used by the replication agents. Indeed, because network bandwidth is continuously needed to provide the replication service, it can become an expensive part of a replication solution. Tracking utilization of resources such as network bandwidth needed for replication over a period of time can then provide a measure of the amount of that resource necessary in order to guarantee a certain RPO.

In other words, the designer of a replication service must determine the amount of bandwidth (or other resource) needed in order to successfully replicate the production system. Unfortunately data transmission in such systems tends to be somewhat bursty in nature, while network bandwidth itself almost exclusively allocated in fixed amounts and must be continuously available. The network bandwidth resources needed for replication therefore tend to be relatively expensive.

What is needed is a way to optimize the expense for a replication resource such as bandwidth needed to achieve a certain RPO, but also taking into account other factors, such as an ability for the environment to tolerate RPOs lagging behind the expected level at least some of the time (that is, an RPO satisfaction of less than 100%).

For example, in a first data processing environment, an RPO of 10 minutes could mean that the replication system must always, 100% of the time, provide complete recovery to within 10 minutes before the disaster, regardless of the spend for bandwidth.

However, in a second environment, there may be some willingness to tolerate RPO failure at least some of the time, in exchange for spending less on bandwidth. In this second scenario, an acceptable RPO of 10 minutes might mean that full recovery 95% of the time is acceptable.

In a third environment, where costs must be controlled even more carefully, a 10 minute recovery might be acceptable as long as it can happen on average (e.g., at least 90% of the time).

In preferred embodiments a replication service, which may be a physical or virtual machine replication service, periodically measures aspects of a production environment in order to estimate the amount of a resource needed to achieve a certain Recovery Point Objective (RPO), taking into account not only an amount of a resource consumed for replication (such as wide area network bandwidth) to indicate a usage metric, but also an RPO failure amount.

More particularly, in a continuous replication environment, the production system will attempt to send data over a wide area network connection to the replication environment as soon as it changes. However, due to the bursty nature of such data, the network connection may become bottlenecked, requiring the caching of such data before it is sent. Thus, one can take a measure of the utilization of the network connection such as by measuring the amount of data stored in the cache and the age of the data at selected time intervals.

In preferred embodiments, time stamped statistical samples of resource usage metrics (such as, for example, the depth of a queue used for disk writes before they are committed) are therefore maintained in the production environment. These data are collected at relatively small sampling intervals from the machines in the production environment, and over a sufficient long period of time to capture real world usage over a significant period of time, such as several days.

Sample times of a minute or less are typically preferred.

The performance metric logs can be collected in the production environment and periodically placed a shared directory for consumption by an analysis tool. The analysis tool may run as a web service separate from either the production environment and/or replication service environment.

In more particular embodiments the tool collects the resource utilization data from the production environment, providing insight to project the best usage of this resource to achieve a stated RPO for a stated failure tolerance.

In more particular aspects the samples taken from different servers in the production environment may be time aligned to provide a measure of overall system bandwidth consumed by the production system as a whole.

In still other aspects, the average usage metric may be compared against a first expected RPO failure tolerance, to determine a first assumed amount of the resource available to achieve a target RPO. This can be repeated for a second expected RPO failure tolerance and a second assumed amount of the available resource to determine what is needed to achieve the same RPO but with a higher tolerance for failure.

By comparing an expected cost of the first and second assumed amount of resource available, the first and second expected RPO failure tolerance, and the first and second target RPOs, an acceptable RPO failure tolerance and resource cost can be determined.

The replicated data processors may be physical machines, virtual machines, or some combination thereof.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of a replication service environment.

FIG. 2 is a high level diagram of elements implemented on the customer side.

FIG. 3 is a high level diagram of elements implemented in a replication service tool that performs a failure risk analysis.

FIG. 4 is an example diagram of data collected showing data rates versus time of day.

FIGS. 5A through 5E show queue depth for different assumed available bandwidths.

FIG. 6A through 6E are histograms of RPO time.

FIG. 7 is a plot showing RPO time versus bandwidth for different replication success percentages.

### DETAILED DESCRIPTION OF EXAMPLE EMBODIMENTS

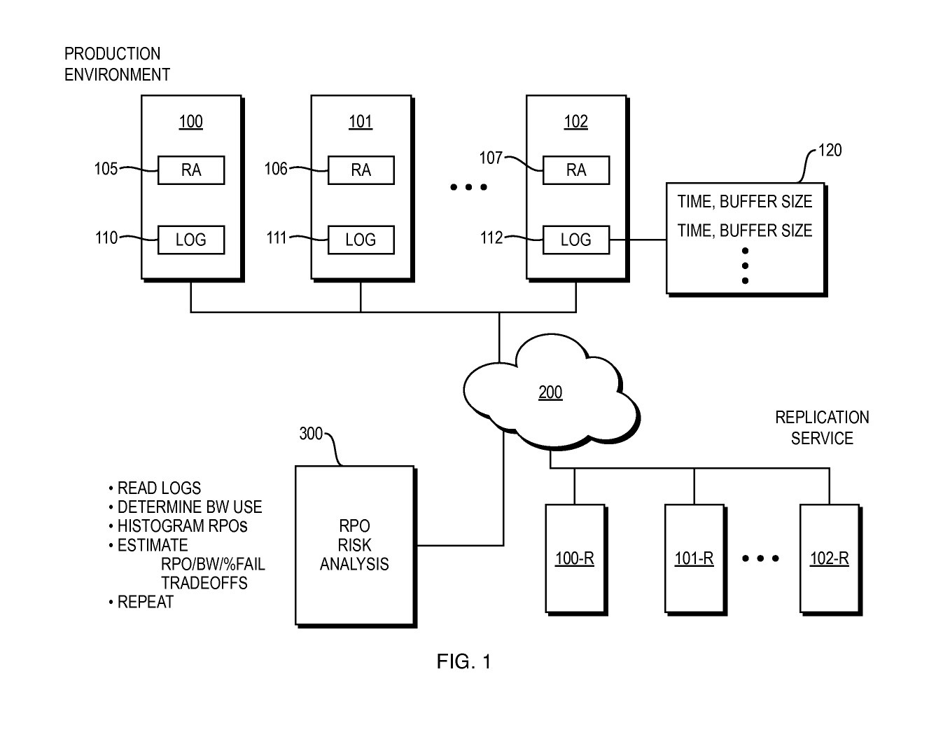

FIG. 1 is a high level block diagram of an environment in which apparatus, systems, and methods for determining an amount of a resource needed for synchronous replication given a Recovery Point Objective (RPO) and an expected tolerance for failure may be implemented. In one example embodiment the resource is bandwidth of a communication link, and the tolerance for failure allows trading off probability of full recovery against the cost of the communication link.

As shown, a production side environment (that is, the customer's side from the perspective of a replication service provider) includes a number of data processors such as production servers 100, 101 . . . 102. The production servers may be physical or virtual.

The production servers are connected to a wide area network (WAN) connection such as made or provided by the Internet, a private network or other network 200 to replication servers 100-R, 101-R, . . . , 102-R. The replication servers are also either physical or virtual servers.

Each of the production servers 100, 101, . . . , 102 may include a respective process, 105, 106, . . . , 107, that performs replication operations. The processes 105, 106, . . . , 107 may be replication agents that operate independently of the production servers in a preferred embodiment but may also be integrated into an application or operating system level process or operate in other ways.

Such replication agents can provide a number of other functions such as encapsulation of system applications and data running in the production environment, and continuously and asynchronously backing these up to target replication servers 100-R, 101-R, . . . , 102-R. More specifically, replication agents 105, 106, . . . , 107 may be responsible for replicating the customer side virtual and/or physical configurations to a replication service provided by target servers 100-R, 101-R, . . . , 102-R. At a time of disaster, the replicated files are transferred to on-demand servers allowing the customer access through a network through their replicated environment. The specific mechanism(s) for replication are not of importance to the present disclosure, and it should be understood that there may be a number of additional data processors and other elements of a commercial replication service such as recovery systems, storage systems, monitoring and management tools that are not shown in detail in FIG. 1 and not needed to understand the present embodiments.

A logging portion 110, 111, . . . , 112 keeps track of utilization of a resource that is needed to successfully implement replication. In a simple case, these may for example, simply consist of keeping a log of time stamped entries as shown in the example log entry 120, including a time of day and a size of write buffer that is being used to cache data before it is written on each processor 100, 101, . . . , 102.

Of further interest in FIG. 1 is a data analysis tool 300 that may execute within the confines of a data processor within the replication environment, but more likely is running as a web service elsewhere in the network. It will be understood shortly that the tool 300 periodically reads the logs 110, 111, . . . , 112, determines usage metrics per interval estimates, and taking a desired RPO with a given percentage probability for failure to replicate in a recovery situation, allows trading off network bandwidth for a recovery failure risk.

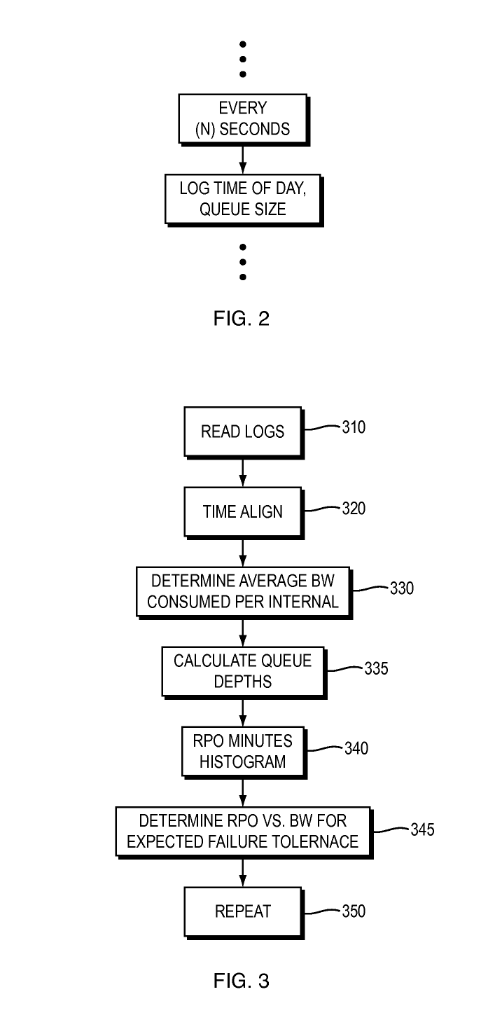

FIG. 2 is an example flow diagram of the steps performed on the production side. At specific time intervals, such as every 15 seconds, the replication agent creates a log entry to record a time stamp and information indicating a bandwidth consumed (which can be measured in different ways, such as by an amount of data presently stored in a local write data buffer waiting to be sent). Since data writes typically occur in bursts in most data processing applications, determining the amount of data waiting to be written is indicative of an amount of bandwidth necessary for the replication agents to successfully complete writing these changes back to the replication servers 100-R, 101-R, . . . , 102-R. These logs are stored over an extended time period, such as several days.

FIG. 3 is a flow diagram of the steps performed to perform a risk analysis, that is—to determine how much of a resource, such as bandwidth, is needed to achieve a certain Recovery Point Objective (RPO) from the log files and given a stated tolerance for failure of the RPO. These steps may be carried out in the web service tool 300.

The logs 110, 111, . . . , 112 are read in step 310 and then a time stamp alignment process occurs in step 320. This step determines, across all of the logs, a common starting point e.g., a common starting time of day. In the preferred embodiment, an assumption is made that the time of day clocks for all production servers 100, 101, . . . , 102 are synchronized; however if they are not, normalization can occur in other ways such as by interpolation.

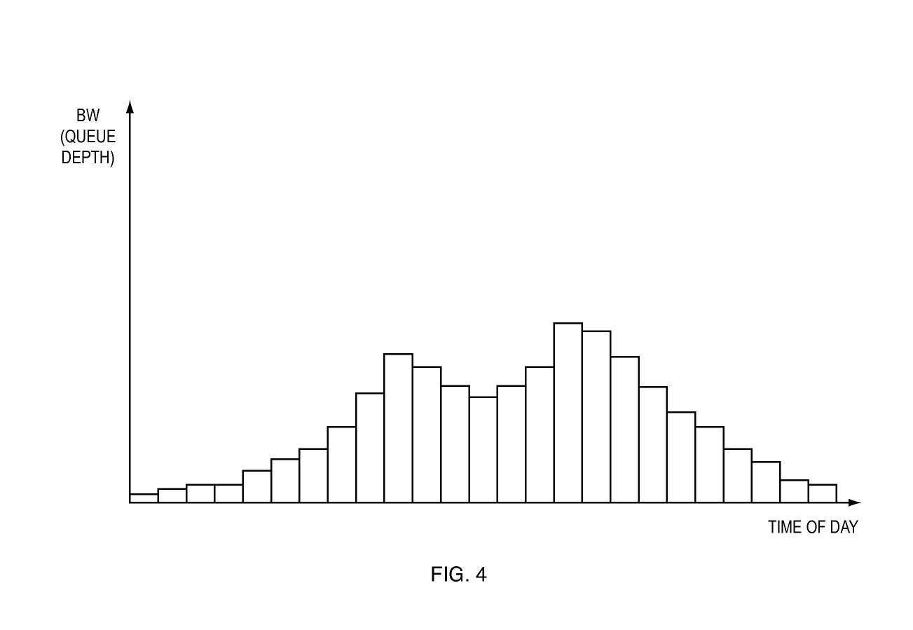

In step 330, a usage metric, such as the average bandwidth consumed is estimated for a number of intervals, such as each hour, over an interval, such one or more days, but typically less than the extended time interval over which all of the samples were taken. An example plot of average bandwidth consumption versus time of day is shown in FIG. 4. Here it is clear that activity in the system increases as the morning progresses, dropping perhaps from a peak of activity around 11:00 AM. then returning to a day-high peak level towards 4 PM and then dropping to minimal usage at night.

It should also be understood that the plot of FIG. 4 may be different for different servers in the production environment. For example, a first server 100 may experience peak utilization at 8:00 a.m. but a second server 101 may have peak utilization at 8:15 a.m. and a third server 102 may peak at 8:02 a.m. What is important in most production environments is to understand the overall collective demand on the bandwidths needed for replication.

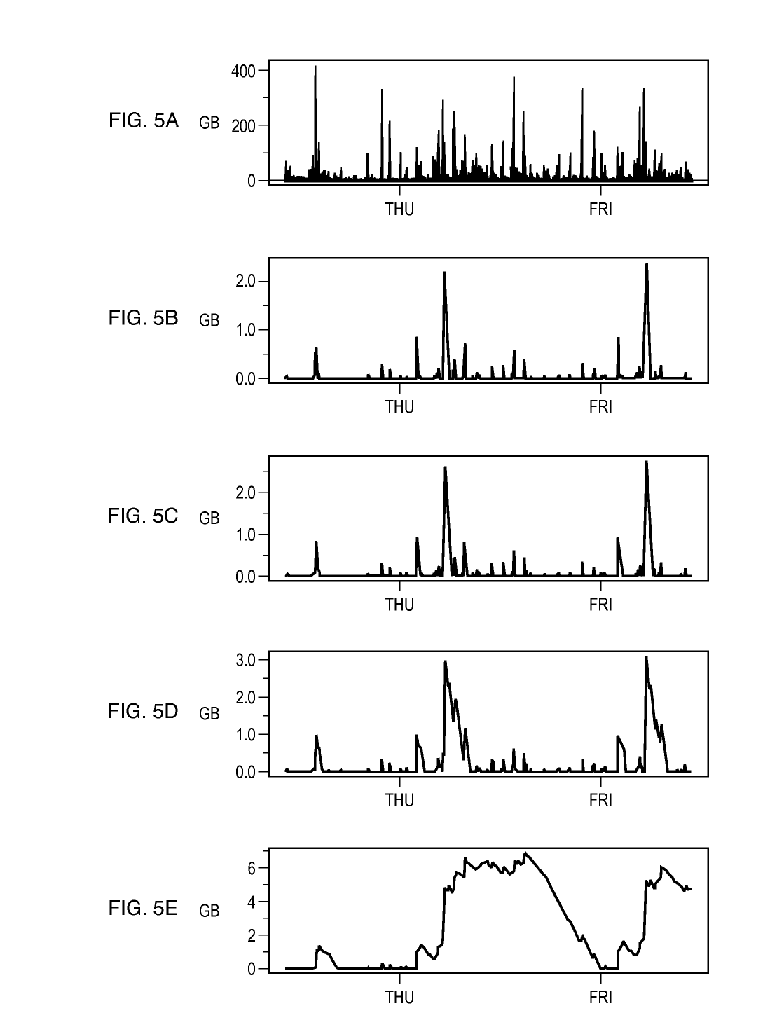

In step 335, the raw input/output bandwidth consumption information can be further processed. For example, FIG. 5A is a plot of the overall system bandwidth consumption rate information as collected starting on Wednesday afternoon, extending through Thursday and into early Friday morning. FIG. 5B through 5E are plots of a corresponding amount of buffer space that would be used over this time interval, assuming different available maximum stated bandwidths—in this case, respectively 20, 15, 10, and 5 Mbps. The data rates shown are corrected by 35%, to effective bandwidths of 13, 9.75, 6.5 and 3.25 Mbps respectively, to account for encryption, headers, overhead protocols, and other aspects of the communications link that reduce the actual bandwidth available for transporting data payloads).

As can be seen, the maximum size of the cache needed increases as the amount of available bandwidth decreases. The expected cache sizes can be calculated as follows:

$$CacheSize ( t ) = CacheSize ( t - 1 ) - BWMax * T$$

$$given$$

$$BWMax = Allocated Bandwidth$$

$$T = sample interval$$

$$t = time$$

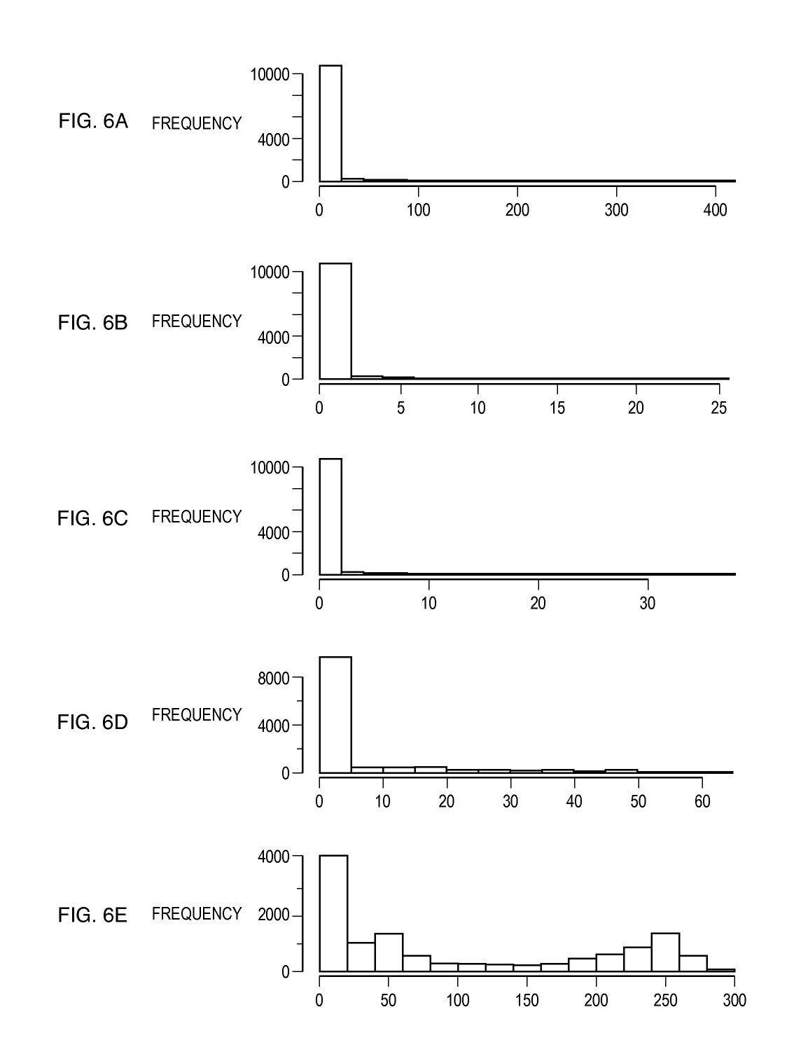

In step 340, one or more RPO minutes histograms can then be determined from the queue depth information for each assumed available bandwidth. Example plots, shown in FIGS. 6A through 6E each correspond to one of the buffer space plots of FIGS. 5A through 5E. For example, FIG. 6B shows that with a 13 Mbps effective bandwidth, an RPO of no more than 7 minutes can be achieved; but that with a 3.25 Mbps effective bandwidth, RPO of 275 minutes will be necessary.

In step 345, the RPO minutes histogram data is further processed using candidate RPO probability of success rates. This information can then be further utilized to determine if an acceptable RPO can be achieved with a lower bandwidth, if the production environment operation is willing to accept that for the certain percentage of time, recovery will not be possible.

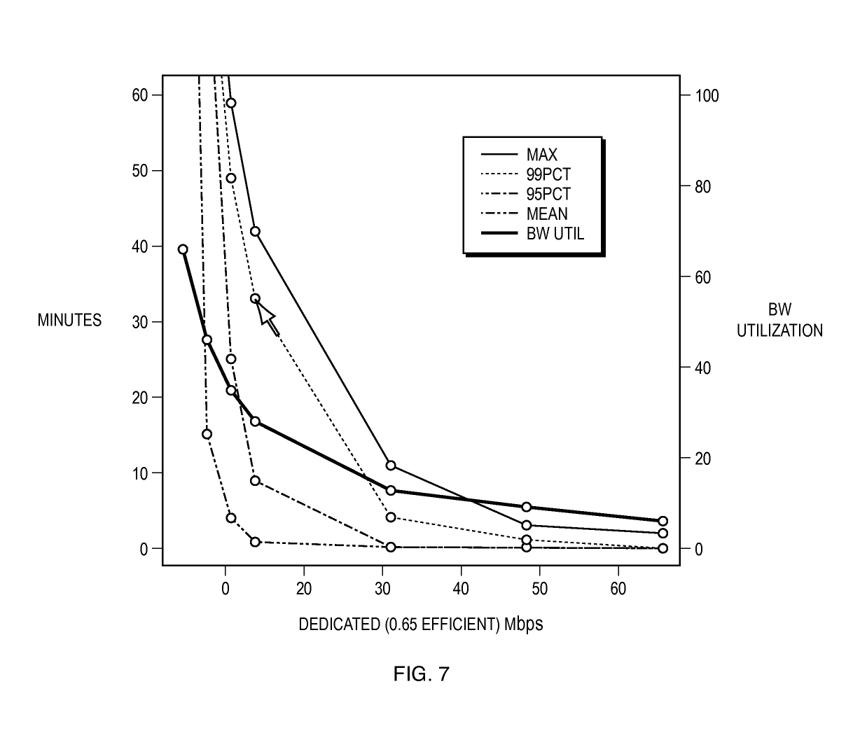

Thus, in step 345, taking the disk usage and available bandwidth as inputs, the percentage of time that a given RPO is achieved can be determined. This can then be repeated for a range of bandwidths. A set of plots such as shown in FIG. 7 can thus be determined as follows:

```
S(t) = S(t−1)[timestamp(cumsum(size(S(t−1))) − BWMax*T > 0)]
Tmax(t) = max(Tmax(t−1), timestamp(cumsum(size(S(t−1))) −
BWMax*T <= 0))
Where
        S(t): vector of tuples (timestamp, size) representing
                first-in-first-out buffer contents at time t
    Tmax(t): timestamp of most recent sample delivered fully to target at
                  time t
        timestamp(S(t)):  vector of timestamps of samples at time t
        size(S(t)):  vector of sizes of samples at time t
```

| | |
|---|---|
| cumsum(v): | the vector whose elements are the cumulative |
| | sums of the elements of the arguments |

| | |
|---|---|
| −: | vector difference |
| +: | vector sum |
| >: | vector greater than |
| <=: | vector less than or equal to |
| [ ]: | index operator timestamp -> (timestamp, size) |

| | |
|---|---|
| RPO(t) = 0 | if CacheSize(t) == 0 |
| t − Tmax(t) | if CacheSize(t) > 0 |

```
        RPO(t): vector of times representing RPO at time t
        Fok(RPOd) = RPOlength(RPO[RPO <= RPOd])/ length(RPO)
        RPOd: desired RPO level
        Fok: fraction of time for which RPO is less than desired RPO
```

As a result one can now engage in not just a tradeoff of RPO versus bandwidth, but also taking into account a tolerance for RPO failure. That is, if the operator of the production environment is willing to take a risk that recovery may not be possible at all for a certain small percentage of the time, it can be determined how a reduced bandwidth can achieve a given RPO. The operator can now factor in their tolerance for failure as part of the risk analysis.

While prior solutions do teach sampling queue depth to determine a maximum needed bandwidth to achieve a certain RPO, they do not recognize an additional degree of freedom, introducing the fact that there may be a tolerance for failure a certain number percentage of time, in exchange for reducing the amount of bandwidth needed.

The teachings of all patents, published applications and references cited herein are incorporated by reference in their entirety.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the risk analysis described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method of risk analysis in determining an amount of a resource needed to accomplish a target Recovery Point Objective (RPO) in a data processing environment, the data processing environment comprising two or more data processors to be replicated, the method comprising:
collecting time-stamped samples of a usage metric for the resource, the samples taken at determined time intervals over a usage period;
storing the time-stamped samples in real-time;
later accessing the stored time-stamped samples to determine an average usage metric at defined intervals;
from the average usage metric, for a first expected RPO failure tolerance, determining a first assumed amount of the resource available to achieve the target RPO; and
repeating one or more of the above steps for at least a second expected replication failure tolerance and a second assumed amount of the available resource.

2. The method of claim 1 wherein the data processors are either physical machines, virtual machines, or some combination thereof.

3. The method of claim 1 wherein the resource needed is bandwidth of a network connection, and the usage metric is a write queue depth.

4. The method of claim 1 additionally comprising:
comparing a cost of the first and second assumed amount of resource available, the first and second expected RPO failure tolerance, and the first and second target RPOs, to determine an acceptable RPO failure tolerance and resource amount.

5. The method of claim 1 wherein the usage period is several days.

6. The method of claim 1 wherein the sample time is several seconds.

7. The method of claim 1 wherein the steps of later accessing the stored time-samples, determining a first and second assumed amount of the resource, and first and second replication tolerance failure are carried out in a data processing system that is accessible as a remote web service.

8. The method of claim 1 additionally comprising:
asynchronously replicating two or more of the data processors using the resource to corresponding replicated data processors at a remote location.

9. An apparatus for determining an amount of a resource needed to accomplish a target Recovery Point Objective (RPO) in a data processing environment, the data processing environment comprising two or more data processors to be replicated, the method comprising:
a buffer memory, for collecting time-stamped samples in real time of a usage metric for the resource, the samples taken at determined time intervals over a usage period;
a risk analysis processor for:
accessing the stored time-stamped samples to determine an average usage metric at defined time intervals;
determining a first assumed amount of the resource available to achieve the target RPO from the average usage metric for a first expected RPO failure tolerance; and
determining at least a second assumed amount of the recourse available for at least a second target RPO and a second expected RPO failure tolerance.

10. The apparatus of claim 9 wherein the data processors are either physical machines, virtual machines, or some combination thereof.

11. The apparatus of claim 9 wherein the resource is bandwidth of a network connection, and the usage metric is a write queue depth.

12. The apparatus of claim 9 additionally comprising:
comparing a cost of the first and second assumed amount of resource available, the first and second expected RPO failure tolerance, and first and second target RPOs, to determine an acceptable RPO failure tolerance and resource amount.

13. The apparatus of claim 9 wherein the usage period is several days.

14. The apparatus of claim 9 wherein the sample time is several seconds.

15. The apparatus of claim 9 wherein the risk analysis processor is a data processing system that is accessible as a remote web service.

16. The apparatus of claim 9 additionally comprising:
asynchronously replicating two or more of the data processors using the resource to corresponding replicated data processors at a remote location.

17. A programmable computer product for performing a risk analysis in determining an amount of a resource needed to accomplish a target Recovery Point Objective (RPO) in a data processing environment, the data processing environment comprising two or more data processors to be replicated, the program product comprising a data processing machine that retrieves instructions from a stored media and executes the instructions, the instructions for:
collecting time-stamped samples of a usage metric for the resource, the samples taken at determined time intervals over a usage period;
storing the time-stamped samples in real-time;
later accessing the stored time-stamped samples to determine an average usage metric at defined intervals;
from the average usage metric, for a first expected RPO failure tolerance, determining a first assumed amount of the resource available to achieve the target RPO; and
repeating one or more of the above steps for at least a second expected replication failure tolerance and a second assumed amount of the available resource.
